(19) United States
(12) Patent Application Publication
(10) Pub. No.: US 2018/0270037 A1
(43) Pub. Date: Sep. 20, 2018

(54) Information Transmission Method and Device

(71) Applicant: Huawei Technologies Co., Ltd., Shenzhen, Guangdong (CN)

(72) Inventors: Da Wang, Beijing (CN); Jian Wang, Beijin (CN); Bin Liu, San Diego, CA (US)

(21) Appl. No.: 15/762,831

(22) PCT Filed: Sep. 24, 2015
(86) PCT No.: PCT/CN2015/090509

§ 371 Date: Mar. 23, 2018

(51) Int. Cl. H04L 5/00; H04W 74/08; H04W 28/26

(52) U.S. Cl. CPC H04L 5/0057; H04W 72/0446; H04W 28/26; H04W 74/085

(57) ABSTRACT

An information transmission method and a device, where the method includes sending, by a first device, a first signal to a second device, where the first signal enables the second device to determine, according to the first signal, a resource location at which the first device sends a second signal or a control signal of the second signal, and send a first signal of the second device at a resource location different from the determined resource location, and sending, by the first device, the second signal or the control signal of the second signal to the second device at the resource location. Therefore, a conflict between the first signal sent by the second device and the second signal sent by the first device can be avoided, so that the second device can quickly and accurately receive the second signal sent by the first device.

### CROSS-REFERENCE TO RELATED APPLICATION

This application is a U.S. National Stage of International Patent Application No. PCT/CN2015/090509 filed on Sep. 24, 2015, which is hereby incorporated by reference in its entirety.

### TECHNICAL FIELD

Embodiments of the present disclosure relate to wireless communications technologies, and in particular, to an information transmission method and a device.

### BACKGROUND

In a vehicle to vehicle (V2V) communication system, each vehicle can be used as an information source to exchange data with a surrounding vehicle in a broadcast or unicast manner and send a V2V signal in a broadcast manner such that information can be efficiently transferred, the surrounding vehicle can be instructed in a special case to perform a security-related operation, and network flexibility can be improved. The V2V signal may be a periodic broadcast signal, for example, a discovery signal that enables a vehicle to be aware of a surrounding vehicle, where the discovery signal includes vehicle status information such as a vehicle speed, a location, an acceleration, and a vehicle identifier (ID), a co-operative awareness message (CAM) signal that is broadcast by a vehicle such as an ambulance or a fire trunk, where the CAM signal includes a vehicle speed, a location, an acceleration, a vehicle ID, a direction, and a driving route, or a decentralized environment notification message DENM) signal that is broadcast by an accident vehicle, where the DENM signal includes a location, a direction, and a vehicle ID.

The V2V communication system is similar to an existing device-to-device (D2D) communication system. Signals transmitted in the D2D system mainly include a D2D discovery signal and a D2D communication signal. The V2V signal that is periodically broadcast in the V2V communication system may be transmitted by transmitting the D2D discovery signal or the D2D communication signal in the D2D communication system. In a process of transmitting the V2V signal, because a V2V device randomly uses a time-frequency resource in a resource pool to send the V2V signal, there is a conflict that a plurality of V2V devices simultaneously select a same time-frequency resource, and because the V2V signal is limited by half-duplex, a V2V signal sent by each of conflicting devices cannot be successfully received by another device. For example, when sending a V2V signal in a subframe b, a device A cannot receive a V2V signal sent by another device in the subframe b using a same frequency or another frequency. To resolve this problem, usually, the V2V signal is consecutively sent in different subframes for at least four times.

If the V2V signal is consecutively sent for a plurality of times, a relatively large delay is caused, and devices cannot quickly receive V2V signals from each other. This disadvantage is tolerable for a discovery signal in the V2V signal. However, for a CAM signal or a DENM signal, traffic accident occurrence probability increases because a CAM signal or a DENM signal sent by a device cannot be successfully received by another device in time.

### SUMMARY

The present disclosure provides an information transmission method and a device such that a conflict between a CAM signal or a DENM signal sent by a device and a discovery signal sent by another device can be avoided, and the other device can quickly and accurately receive the CAM signal or the DENM signal sent by the device.

According to a first aspect, an embodiment of the present disclosure provides an information transmission method, including sending, by a first device, a first signal to a second device, where the first signal is used to enable the second device to determine, according to the first signal, a resource location at which the first device sends a second signal or a control signal of the second signal, and send a first signal of the second device at a resource location different from the determined resource location, and sending, by the first device, the second signal or the control signal of the second signal to the second device at the resource location.

In a first possible implementation of the first aspect, the first signal carries first resource location indication information, and the first resource location indication information is used to indicate a first resource location at which the first device sends the second signal or the control signal of the second signal.

With reference to the first possible implementation of the first aspect, in a second possible implementation of the first aspect, the first resource location indication information includes at least one bit, used to indicate whether to send the second signal in a next period of a current period, and a resource bitmap, a control signal index, or at least two of a physical resource block (PRB) start location, a PRB end location, or a PRB quantity, used to indicate the resource location used for sending the second signal or the control signal of the second signal.

With reference to the first aspect, the first possible implementation of the first aspect, or the second possible implementation of the first aspect, in a third possible implementation of the first aspect, sending, by a first device, a first signal to a second device includes determining, by the first device, a second resource location and a third resource location according to a transmission pattern, where the transmission pattern includes a time axis and a frequency axis, the time axis includes N time points (T₁, T₂, . . . , and T_{N}), the frequency axis includes N frequency points (f₁, f₂, . . . , and f_{N}), and each pair of coordinates (Tₓ, f_{y}) in the transmission pattern corresponds to a resource location, the second resource location corresponds to first coordinates (Tᵢ, fⱼ) in the transmission pattern, and the third resource location corresponds to second coordinates (T_{(i+m)modN}, fⱼ) or (T_{(i+P)mod N}, f_{(i+q)mod N}) in the transmission pattern, where N, i, j, x, and y are positive integers, none of i, j, x, and y are greater than N, i+m≤N, and m, p, and q are 0 or positive integers, and sending, by the first device, the first signal to the second device at the second resource location, and sending the first signal to the second device at the third resource location.

With reference to the third possible implementation of the first aspect, in a fourth possible implementation of the first aspect, sending, by the first device, the second signal to the second device at the resource location includes determining, by the first device, a fourth resource location and a fifth resource location according to the transmission pattern, where the fourth resource location is the first resource location indicated by the first resource location indication information, and sending, by the first device, the second signal to the second device at the fourth resource location, and sending the second signal to the second device at the fifth resource location, or sending, by the first device, the second signal to the second device at the fourth resource location, and skip, by the first device, sending the second signal at the fifth resource location.

With reference to any one of the first aspect, or the first to the fourth possible implementations of the first aspect, in a fifth possible implementation of the first aspect, after sending, by the first device, the second signal to the second device at the resource location, the method further includes sending, by the first device to the second device at a resource location different from the resource location used for sending the second signal, a first signal that carries second resource location indication information, where the second resource location indication information is used to notify the second device of a sixth resource location at which the first device sends the second signal or the control signal of the second signal.

With reference to any one of the first aspect, or the first to the fourth possible implementations of the first aspect, in a sixth possible implementation of the first aspect, after sending, by the first device, the second signal to the second device at the resource location, the method further includes receiving, by the first device, a first signal that carries the first resource location indication information and that is sent by a device belonging to a same area as the first device, where the device belonging to the same area as the first device includes a device whose physical location belongs to a same area as the first device or a device whose first signal occupies a resource location in a same area as the first device.

In a seventh possible implementation of the first aspect, after sending, by a first device, a first signal to a second device, the method further includes determining, by the first device according to a preset relationship and a resource location used for sending the first signal, the resource location at which the first device sends the second signal or the control signal of the second signal, where the preset relationship is a relationship between the resource location used for sending the first signal and the resource location used for sending the second signal or the control signal of the second signal, and the preset relationship is pre-stored on the first device and the second device.

With reference to the seventh possible implementation of the first aspect, in an eighth possible implementation of the first aspect, sending, by a first device, a first signal to a second device includes determining, by the first device, a second resource location and a third resource location according to a transmission pattern, where the transmission pattern includes a time axis and a frequency axis, the time axis includes N time points (T₁, T₂, . . . , and T_{N}), the frequency axis includes N frequency points (f₁, f₂, . . . , and f_{N}), and each pair of coordinates (Tₓ, f_{y}) in the transmission pattern corresponds to a resource location, the second resource location corresponds to first coordinates (Tᵢ, fⱼ) in the transmission pattern, and the third resource location corresponds to second coordinates (T_{(i+m)modN}, fⱼ) or (T_{(i+P)modN}, f_{(i+q)modN}) in the transmission pattern, where N, i, j, x, and y are positive integers, none of i, j, x, and y are greater than N, i+m≤N, and m, p, and q are 0 or positive integers, sending, by the first device, the first signal to the second device at the second resource location, and sending the first signal to the second device at the third resource location.

With reference to the eighth possible implementation of the first aspect, in a ninth possible implementation of the first aspect, sending, by the first device, the second signal to the second device at the resource location includes determining, by the first device, a fourth resource location and a fifth resource location according to the transmission pattern, where the fourth resource location is the resource location, and sending, by the first device, the second signal to the second device at the fourth resource location, and sending the second signal to the second device at the fifth resource location, or sending, by the first device, the second signal to the second device at the fourth resource location, and skip, by the first device, sending the second signal at the fifth resource location.

According to a second aspect, an embodiment of the present disclosure provides an information transmission method, including receiving, by a second device, a first signal sent by a first device, determining, by the second device according to the first signal, a resource location at which the first device sends a second signal or a control signal of the second signal, and sending a first signal of the second device to the first device at a resource location different from the determined resource location, and receiving, by the second device, the second signal or the control signal of the second signal that is sent by the first device at the resource location.

In a first possible implementation of the second aspect, the first signal carries first resource location indication information, and the first resource location indication information is used to indicate a first resource location at which the first device sends the second signal or the control signal of the second signal.

With reference to the first possible implementation of the second aspect, in a second possible implementation of the second aspect, the first resource location indication information includes at least one bit, used to indicate whether to send the second signal in a next period of a current period, and a resource bitmap, a control signal index, or at least two of a PRB start location, a PRB end location, or a PRB quantity, used to indicate the resource location used for sending the second signal or the control signal of the second signal.

In a third possible implementation of the second aspect, determining, by the second device according to the first signal, a resource location at which the first device sends a second signal or a control signal of the second signal includes determining, by the second device according to a preset relationship and a resource location used for sending the first signal, the resource location at which the first device sends the second signal or the control signal of the second signal, where the preset relationship is a relationship between the resource location used for sending the first signal and the resource location used for sending the second signal or the control signal of the second signal, and the preset relationship is pre-stored on the first device and the second device.

According to a third aspect, an embodiment of the present disclosure provides a communications device that is used as a first device and includes a processor and a transceiver, where the processor is configured to send a first signal to a second device using the transceiver, where the first signal is used to enable the second device to determine, according to the first signal, a resource location at which the first device sends a second signal or a control signal of the second signal, and send a first signal of the second device at a resource location different from the determined resource location, and send the second signal or the control signal of the second signal to the second device at the resource location using the transceiver.

In a first possible implementation of the third aspect, the first signal carries first resource location indication information, and the first resource location indication information is used to indicate a first resource location at which the first device sends the second signal or the control signal of the second signal.

With reference to the first possible implementation of the third aspect, in a second possible implementation of the third aspect, the first resource location indication information includes at least one bit, used to indicate whether to send the second signal in a next period of a current period, and a resource bitmap, a control signal index, or at least two of a PRB start location, a PRB end location, or a PRB quantity, used to indicate the resource location used for sending the second signal or the control signal of the second signal.

With reference to the third aspect, the first possible implementation of the third aspect, or the second possible implementation of the third aspect, in a third possible implementation of the third aspect, when sending the first signal to the second device using the transceiver, the processor is further configured to determine a second resource location and a third resource location according to a transmission pattern, send the first signal to the second device at the second resource location, and send the first signal to the second device at the third resource location, where the transmission pattern includes a time axis and a frequency axis, the time axis includes N time points (T₁, T₂, . . . , and T_{N}), the frequency axis includes N frequency points (f₁, f₂, . . . , and f_{N}), and each pair of coordinates (Tₓ, f_{y}) in the transmission pattern corresponds to a resource location, the second resource location corresponds to first coordinates (Tᵢ, fⱼ) in the transmission pattern, and the third resource location corresponds to second coordinates (T_{(i+m)modN}, fⱼ) or (T_{(i+P)mod N}, f_{(i+q)mod N}) in the transmission pattern, where N, i, j, x, and y are positive integers, none of i, j, x, and y are greater than N, i+m≤N, and m, p, and q are 0 or positive integers.

With reference to the third possible implementation of the third aspect, in a fourth possible implementation of the third aspect, when sending the second signal to the second device at the resource location using the transceiver, the processor is further configured to determine a fourth resource location and a fifth resource location according to the transmission pattern, where the fourth resource location is the first resource location indicated by the first resource location indication information, and send the second signal to the second device at the fourth resource location using the transceiver, and send the second signal to the second device at the fifth resource location using the transceiver, or send the second signal to the second device at the fourth resource location using the transceiver, and skip sending the second signal at the fifth resource location.

With reference to any one of the third aspect, or the first to the fourth possible implementations of the third aspect, in a fifth possible implementation of the third aspect, the processor is further configured to send, to the second device using the transceiver and a resource location different from the resource location used for sending the second signal, a first signal that carries second resource location indication information after sending the second signal to the second device at the resource location using the transceiver, where the second resource location indication information is used to notify the second device of a sixth resource location at which the first device sends the second signal or the control signal of the second signal.

With reference to any one of the third aspect, or the first to the fourth possible implementations of the third aspect, in a sixth possible implementation of the third aspect, the processor is further configured to receive, using the transceiver, a first signal that carries the first resource location indication information and that is sent by a device belonging to a same area as the first device after sending the second signal to the second device at the resource location using the transceiver, where the device belonging to the same area as the first device includes a device whose physical location belongs to a same area as the first device or a device whose first signal occupies a resource location in a same area as the first device.

In a seventh possible implementation of the third aspect, after sending the first signal to the second device using the transceiver, the processor is further configured to determine, according to a preset relationship and a resource location used for sending the first signal, the resource location at which the first device sends the second signal or the control signal of the second signal, where the preset relationship is a relationship between the resource location used for sending the first signal and the resource location used for sending the second signal or the control signal of the second signal, and the preset relationship is pre-stored on the first device and the second device.

With reference to the seventh possible implementation of the third aspect, in an eighth possible implementation of the third aspect, when sending the first signal to the second device using the transceiver, the processor is further configured to determine a second resource location and a third resource location according to a transmission pattern, send the first signal to the second device at the second resource location using the transceiver, and send the first signal to the second device at the third resource location using the transceiver, where the transmission pattern includes a time axis and a frequency axis, the time axis includes N time points (T₁, T₂, . . . , and T_{N}), the frequency axis includes N frequency points (f₁, f₂, . . . , and f_{N}), and each pair of coordinates (Tₓ, f_{y}) in the transmission pattern corresponds to a resource location, the second resource location corresponds to first coordinates (Tᵢ, fⱼ) in the transmission pattern, and the third resource location corresponds to second coordinates (T_{(i+m)modN}, fⱼ) or (T_{(i+p)modN}, f_{(i+q)modN}) in the transmission pattern, where N, i, j, x, and y are positive integers, none of i, j, x, and y are greater than N, i+m≤N, and m, p, and q are 0 or positive integers.

With reference to the eighth possible implementation of the third aspect, in a ninth possible implementation of the third aspect, when sending the second signal to the second device at the resource location using the transceiver, the processor is further configured to determine a fourth resource location and a fifth resource location according to the transmission pattern, where the fourth resource location is the resource location, and send the second signal to the second device at the fourth resource location using the transceiver, and send the second signal to the second device at the fifth resource location using the transceiver, or send the second signal to the second device at the fourth resource location using the transceiver, and skip sending the second signal at the fifth resource location.

According to a fourth aspect, an embodiment of the present disclosure provides a communications device that is used as a second communications device and includes a processor and a transceiver, where the processor is configured to receive, using the transceiver, a first signal sent by a first device, determine, according to the first signal, a resource location at which the first device sends a second signal or a control signal of the second signal, and send a first signal of the communications device to the first device at a resource location different from the determined resource location, and receive, using the transceiver, the second signal or the control signal of the second signal that is sent by the first device at the resource location.

In a first possible implementation of the fourth aspect, the first signal carries first resource location indication information, and the first resource location indication information is used to indicate a first resource location at which the first device sends the second signal or the control signal of the second signal.

With reference to the first possible implementation of the fourth aspect, in a second possible implementation of the fourth aspect, the first resource location indication information includes at least one bit, used to indicate whether to send the second signal in a next period of a current period, and a resource bitmap, a control signal index, or at least two of a PRB start location, a PRB end location, or a PRB quantity, used to indicate the resource location used for sending the second signal or the control signal of the second signal.

In a third possible implementation of the fourth aspect, when determining, according to the first signal, the resource location at which the first device sends the second signal or the control signal of the second signal, the processor is further configured to determine, according to a preset relationship and a resource location used for sending the first signal, the resource location at which the first device sends the second signal or the control signal of the second signal, where the preset relationship is a relationship between the resource location used for sending the first signal and the resource location used for sending the second signal or the control signal of the second signal, and the preset relationship is pre-stored on the first device and the second device.

According to the information transmission method and the device provided in the embodiments, the first device sends the first signal to the second device, after receiving the first signal, the second device determines, according to the first signal, the resource location at which the first device sends the second signal or the control signal of the second signal, when sending the first signal of the second device, the second device does not use a resource location that is the same as the resource location at which the first device sends the second signal or the control signal of the second signal, but selects another available resource location, and the first device sends the second signal to the second device at the determined resource location. Therefore, a conflict between the first signal sent by the second device and the second signal sent by the first device can be avoided such that the second device can quickly and accurately receive the second signal sent by the first device.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show merely some embodiments of the present disclosure, and persons of ordinary skill in the art may still derive other drawings from these accompanying drawings without creative efforts.

FIG. 1 is a schematic flowchart of Embodiment 1 of an information transmission method according to the present disclosure;

FIG. 2 is a schematic flowchart of Embodiment 2 of an information transmission method according to the present disclosure;

FIG. 3 is a schematic flowchart of Embodiment 3 of an information transmission method according to the present disclosure;

FIG. 4 is a schematic flowchart of Embodiment 4 of an information transmission method according to the present disclosure;

FIG. 5 is a schematic diagram of a transmission pattern according to an embodiment of the present disclosure;

FIG. 6 is a schematic diagram of locations in a transmission pattern corresponding to resource locations used by different devices according to an embodiment of the present disclosure;

FIGS. 7A, 7B, 7C are a schematic diagram of transmission patterns in which a device A and other devices 2 to 9 adjacent to the device A send a discovery signal twice in one period;

FIGS. 8A and 8B are a schematic diagram of a first resource location and a second resource location that are determined by a device A according to a transmission pattern;

FIGS. 9A, 9B and 9C are a schematic diagram of resource locations indicated by resource location indication information carried in two times of sending a new discovery signal by a device A;

FIG. 10 is a schematic flowchart of Embodiment 5 of an information transmission method according to the present disclosure;

FIG. 11 is a schematic structural diagram of Embodiment 1 of a communications device according to the present disclosure;

FIG. 12 is a schematic structural diagram of Embodiment 2 of a communications device according to the present disclosure;

FIG. 13 is a schematic structural diagram of Embodiment 3 of a communications device according to the present disclosure; and

FIG. 14 is a schematic structural diagram of Embodiment 4 of a communications device according to the present disclosure.

### DESCRIPTION OF EMBODIMENTS

The following clearly and completely describes the technical solutions in the embodiments of the present disclosure with reference to the accompanying drawings in the embodiments of the present disclosure. The described embodiments are merely some but not all of the embodiments of the present disclosure. All other embodiments obtained by persons of ordinary skill in the art based on the embodiments of the present disclosure without creative efforts shall fall within the protection scope of the present disclosure.

Embodiments of the present disclosure provide an information transmission method and a device such that a conflict between a CAM signal or a DENM signal sent by a device in a V2V system and a discovery signal sent by another device can be avoided, and the other device can quickly and accurately receive the CAM signal or the DENM signal sent by the device. The device in this specification may be understood as any moving device in an area, such as a vehicle traveling in a lane, a flying device flying in the air, or a ship travelling on a waterway, or may be a high-speed moving device such as a satellite running in an orbit. A specific application scenario is not limited in this specification. The CAM signal or the DENM signal may be another signal, and the discovery signal may also be another signal.

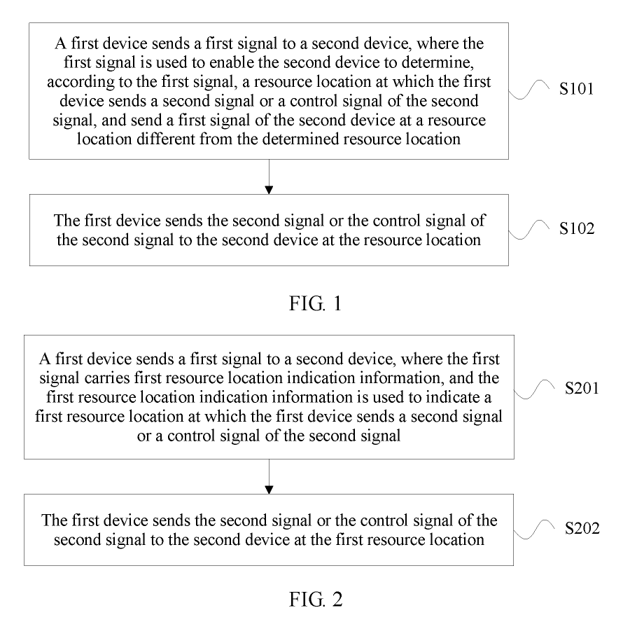

FIG. 1 is a schematic flowchart of Embodiment 1 of an information transmission method according to the present disclosure. As shown in FIG. 1, the method in this embodiment may include the following steps.

Step S101: A first device sends a first signal to a second device, where the first signal is used to enable the second device to determine, according to the first signal, a resource location at which the first device sends a second signal or a control signal of the second signal, and send a first signal of the second device at a resource location different from the determined resource location.

Further, the second signal may be a CAM signal or a DENM signal, and the first signal may be a discovery signal. The first device randomly selects a resource from a pre-configured resource pool to send the first signal. There may be a plurality of second devices. When there are a plurality of second devices, the first device broadcasts the first signal to another device.

When the second signal is sent using a D2D discovery channel, the second device needs to determine, according to a resource location used for sending the first signal, the resource location at which the first device sends the second signal. When the second signal is sent using a D2D communication channel, the second device needs to determine, according to a resource location used for sending the first signal, the resource location at which the first device sends the control signal of the second signal.

Step S102: The first device sends the second signal or the control signal of the second signal to the second device at the resource location.

According to the information transmission method provided in this embodiment, the first device sends the first signal to the second device. After receiving the first signal, the second device determines, according to the first signal, the resource location at which the first device sends the second signal or the control signal of the second signal. When sending the first signal of the second device, the second device does not use a resource location that is the same as the resource location at which the first device sends the second signal or the control signal of the second signal, but selects another available resource location, and the first device sends the second signal to the second device at the determined resource location. Therefore, a conflict between the first signal sent by the second device and the second signal sent by the first device can be avoided such that the second device can quickly and accurately receive the second signal sent by the first device.

FIG. 2 is a schematic flowchart of Embodiment 2 of an information transmission method according to the present disclosure. As shown in FIG. 2, the method in this embodiment may include the following steps.

Step S201: A first device sends a first signal to a second device, where the first signal carries first resource location indication information, and the first resource location indication information is used to indicate a first resource location at which the first device sends a second signal or a control signal of the second signal.

Further, the first resource location is learned by the first device in advance before the first device sends the first signal. The first resource location is learned in two manners. In a first manner, the first resource location is randomly selected before the first device sends the first signal to the second device. In a second manner, the first device receives and stores the first resource location sent by a base station.

Step S202: The first device sends the second signal or the control signal of the second signal to the second device at the first resource location.

In this embodiment of the present disclosure, the first signal sent by the first device to the second device carries the first resource location indication information. When the second signal is sent using a D2D discovery channel, the first resource location indication information is used to indicate the resource location at which the first device sends the second signal. After receiving the first signal, when sending a first signal of the second device, the second device does not use a resource location that is the same as the resource location at which the first device sends the second signal, but selects another available resource location. A resource location that is different in a time domain or both a time domain and a frequency domain may be selected. Therefore, a conflict between the first signal sent by the second device and the second signal sent by the first device can be avoided such that the second device can quickly and accurately receive the second signal sent by the first device. Alternatively, the first signal may be a communication signal. In this case, when sending the first signal, the first device randomly selects a resource location from a pre-configured resource pool to send a control signal of the communication signal, and then sends the communication signal. The control signal indicates a resource location used for sending the communication signal. In this embodiment of the present disclosure, when the second signal is sent using a D2D communication channel, the first resource location indication information is used to indicate the resource location at which the first device sends the control signal of the second signal. After receiving the first signal, when sending a first signal of the second device, the second device does not use the resource location at which the first device sends the control signal of the second signal for sending, but selects another available resource location. Therefore, a conflict between the first signal sent by the second device and the second signal sent by the first device can be avoided such that the second device can quickly and accurately receive the second signal sent by the first device.

The first resource location indication information includes at least one bit, used to indicate whether to send the second signal in a next period of a current period. For example, “1” represents yes, and “0” represents no. The first signal may include a resource bitmap, a control signal index, or at least two of a PRB start location, a PRB end location, or a PRB quantity, used to indicate the resource location used for sending the second signal or the control signal of the second signal. One PRB is a minimum unit of a resource location. One PRB occupies 12 consecutive subcarriers in a frequency domain, and occupies one timeslot in a time domain. A length of one timeslot is 0.5 milliseconds (ms). A resource occupied by a sending signal may include a plurality of PRBs, for example, two PRBs. In this case, the occupied resource includes 12 consecutive subcarriers in the frequency domain, and includes one subframe in the time domain, where a length of one subframe is 1 ms, or includes 24 consecutive subcarriers in the frequency domain, and includes one timeslot in the time domain.

After sending the second signal to the second device according to the resource location indication information for a first time, the first device periodically sends the second signal at the first resource location according to a preset period. When the first device sends the second signal, the first signal of the first device may be sent at a resource location different from the resource location used for sending the second signal, or may not be sent.

In a possible implementation, when the first signal (which is a new first signal) of the first device is sent at the resource location different from the resource location used for sending the second signal, the first device sends, to the second device at the resource location different from the resource location used for sending the second signal, a first signal that carries second resource location indication information. The second resource location indication information is used to notify the second device of a sixth resource location at which the first device sends the second signal or the control signal of the second signal. One purpose of this operation is to avoid a problem that some device is always at a location in a dead zone of the resource location at which the first device sends the second signal and can never receive the second signal sent by the first device at the resource location. Another purpose includes if a new device is added to an area in which the first device is located, the new device may receive the first signal of the first device, and learn the resource location at which the first device sends the second signal such that when selecting a resource location used for sending a first signal of the new device, the new device avoids the resource location at which the first device sends the second signal, and can quickly and successfully receive the second signal sent by the first device.

Further, in another possible implementation, because both the first signal and the second signal are limited by half-duplex, when sending a first signal, a device (referred to as a device for which an occupied resource location and the resource location occupied by the first device are dead zones for each other) that occupies a resource location that is the same, in the time domain, as the resource location occupied by the first device can never receive the first signal sent by the first device. In this case, after sending, by the first device, the second signal to the second device at the first resource location, the method further includes receiving, by the first device, a first signal that carries the first resource location indication information and that is sent by a device belonging to a same area as the first device, where the device belonging to the same area as the first device includes a device whose physical location belongs to a same area as the first device or a device whose discovery signal occupies a resource in a same area as the first device. That is, after receiving the first signal that carries the first resource location indication information and that is sent by the first device, the device belonging to the same area as the first device broadcasts, to another device, the resource location at which the first device sends the second signal, and adds, to a first signal to be sent by the device belonging to the same area as the first device, the resource location indication information that indicates the first resource location. In this way, the device for which the occupied resource location and the resource location occupied by the first device are dead zones for each other may determine, according to the first signal of the device belonging to the same area as the first device, the resource location at which the first device sends the second signal. It should be noted that there may be one device that belongs to a same area as the first device and that sends, to the other device, the first signal carrying the first resource location indication information in order to further save resources.

According to the information transmission method provided in this embodiment, the first signal sent by the first device to the second device carries the first resource location indication information, and the first resource location indication information is used to indicate the first resource location at which the first device sends the second signal or the control signal of the second signal. The first device sends the second signal to the second device at the first resource location, and after receiving the first signal, when sending a first signal of the second device, the second device does not use a resource location that is the same as the first resource location, but selects another available resource location. Therefore, a conflict between the first signal sent by the second device and the second signal sent by the first device can be avoided such that the second device can quickly and accurately receive the second signal sent by the first device.

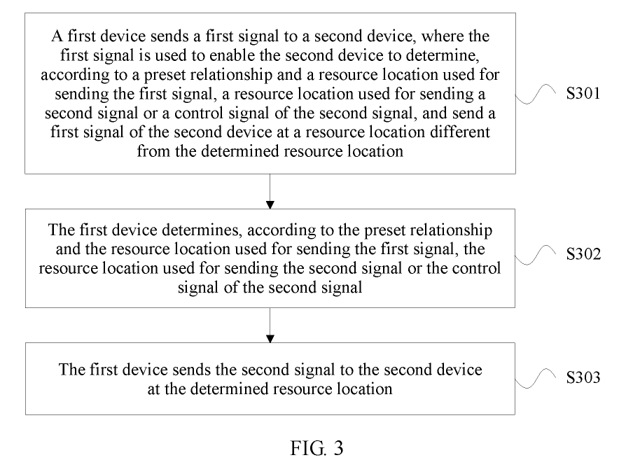

FIG. 3 is a schematic flowchart of Embodiment 3 of an information transmission method according to the present disclosure. As shown in FIG. 3, the method in this embodiment may include the following steps.

Step S301: A first device sends a first signal to a second device, where the first signal is used to enable the second device to determine, according to a preset relationship and a resource location used for sending the first signal, a resource location used for sending a second signal or a control signal of the second signal, and send a first signal of the second device at a resource location different from the determined resource location.

Step S302: The first device determines, according to the preset relationship and the resource location used for sending the first signal, the resource location used for sending the second signal or the control signal of the second signal.

The preset relationship is a relationship between the resource location used for sending the first signal and the resource location used for sending the second signal or the control signal of the second signal, and the preset relationship is pre-stored on the first device and the second device.

Further, the preset relationship may be a calculation formula. The preset relationship may be configured by a third-party device (such as a base station or a control node) for the first device and the second device, or the preset relationship may be generated by the first device, the first device generates the preset relationship and then sends the relationship to the second device, and the preset relationship may be sent together with the first signal or may be sent before or after the first signal. It should be noted that regardless of whether the preset relationship is configured by the third-party device or generated by the first device, the preset relationship takes effect after the second signal is triggered. For example, whether the second signal is sent may be indicated in the first signal (for example, indicated by the at least one bit in Embodiment 2), and if the second signal is sent, the second signal is triggered. Such triggering may be independent of the first signal, and the second device is notified on another channel that the second signal is triggered.

Step S303: The first device sends the second signal to the second device at the determined resource location.

According to the information transmission method provided in this embodiment, the first device sends the first signal to the second device, after receiving the first signal, the second device determines, according to the preset relationship and the resource location used for sending the first signal, the resource location used for sending the second signal or the control signal of the second signal, when sending the first signal of the second device, the second device does not use a resource location that is the same as the resource location at which the first device sends the second signal, but selects another available resource location, and the first device determines, according to the preset relationship and the resource location used for sending the first signal, the resource location used for sending the second signal or the control signal of the second signal, and finally sends the second signal to the second device at the determined resource location. Therefore, a conflict between the first signal sent by the second device and the second signal sent by the first device can be avoided such that the second device can quickly and accurately receive the second signal sent by the first device.

When the first signal is a discovery signal, because the first device randomly selects a resource from a pre-configured resource pool to send the first signal, there is a conflict that a plurality of devices simultaneously select a same time-frequency resource, and because the first signal is limited by half-duplex, a first signal sent by each of conflicting devices cannot be successfully received by another device. Even if the first signal is consecutively sent for a plurality of times, devices cannot quickly receive first signals from each other, and consequently implementation of the solution in the foregoing embodiment is also greatly affected. Therefore, the following embodiment of the present disclosure provides an information transmission method such that devices quickly receive first signals from each other, and a second signal sent by a device or second signals sent by a plurality of devices can be quickly and accurately received. That the first signal carries the first resource location indication information in the embodiment shown in FIG. 2 is used as an example. A further solution in the embodiment shown in FIG. 3 is similar to that in the embodiment shown in FIG. 2, and is described in detail below with reference to the accompanying drawings.

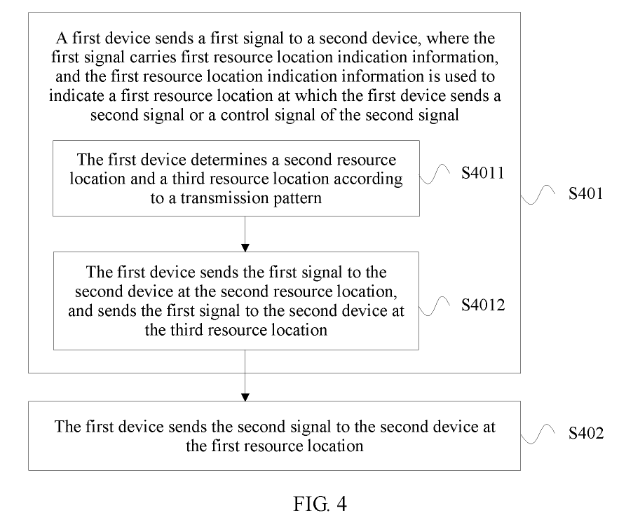

FIG. 4 is a schematic flowchart of Embodiment 4 of an information transmission method according to the present disclosure. As shown in FIG. 4, the method in this embodiment may include the following steps.

Step S401: A first device sends a first signal to a second device, where the first signal carries first resource location indication information, and the first resource location indication information is used to indicate a first resource location at which the first device sends a second signal or a control signal of the second signal.

The first device sending the first signal to the second device includes the following steps.

Step S4011: The first device determines a second resource location and a third resource location according to a transmission pattern.

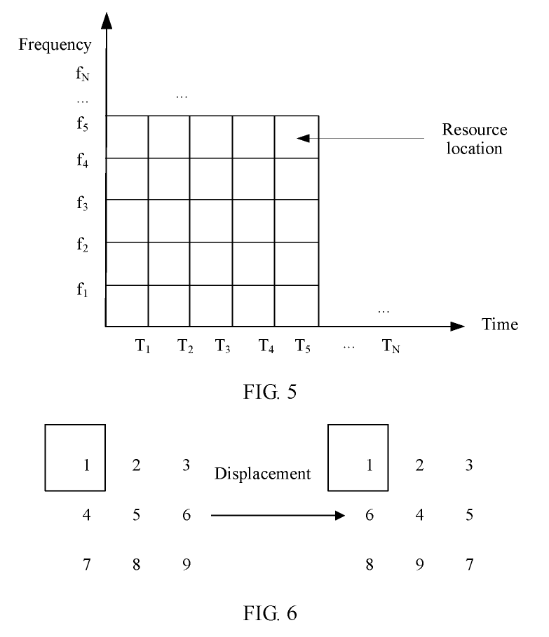

Each unit in the transmission pattern corresponds to a resource location in a preset resource pool. FIG. 5 is a schematic diagram of a transmission pattern according to an embodiment of the present disclosure. As shown in FIG. 5, the transmission pattern includes a time axis and a frequency axis, the time axis includes N time points (T₁, T₂, . . . , and T_{N}), the frequency axis includes N frequency points (f₁, f₂, . . . , and f_{N}), and each pair of coordinates (Tₓ, f_{y}) in the transmission pattern corresponds to a resource location. The second resource location corresponds to first coordinates (Tᵢ, fⱼ) in the transmission pattern, and the third resource location corresponds to second coordinates (T_{(i+m)modN}, fⱼ) or (T_{(i+P)modN}, f_{(i+q)modN}) in the transmission pattern, where N, i, j, x, and y are positive integers, none of i, j, x, and y are greater than N, i+m≤N, and m, p, and q are 0 or positive integers.

Step S4012: The first device sends the first signal to the second device at the second resource location, and sends the first signal to the second device at the third resource location.

The transmission pattern specifies a rule for selecting resource locations used by the first device to send the first signal for two consecutive times. Two times of sending are used as one period. After determining, according to the transmission pattern, the resource locations at which the two consecutive times of sending are performed, the first device periodically sends the first signal. The first resource location indication information is carried in both times of sending the first signal in one period. The carried first resource location indication information may be the same or may be different. When the carried first resource location indication information is different, the first device may determine, according to resource location indication information in either of the two times, the resource location used for sending the second signal or the control signal of the second signal. In another implementation, if the first resource location is different from the second resource location, the first device may determine, according to a resource location in either of the two times and a preset relationship, the resource location used for sending the second signal or the control signal of the second signal.

Step S402: The first device sends the second signal to the second device at the first resource location.

In this embodiment, the first device sends the first signal at the two resource locations determined according to the transmission pattern, and the two resource locations are different at least in a time domain. To some extent, a conflict that a plurality of devices simultaneously select a same time-frequency resource because the device randomly uses a time-frequency resource in a resource pool to send the first signal can be effectively avoided such that devices quickly receive first signals from each other, and a second signal sent by a device or second signals sent by a plurality of devices can be more quickly and accurately received.

Based on Embodiment 2, further, when the first signal carries the first resource location indication information, because magnitude of the second signal and magnitude of the first signal may be the same or may be different, when the magnitude of the second signal and the magnitude of the first signal are the same, a resource location indicated by the first resource location indication information corresponds to one pair of coordinates in the transmission pattern, or when the magnitude of the second signal and the magnitude of the first signal are different, a resource location indicated by the first resource location indication information corresponds to a plurality of coordinates in the transmission pattern. When sending the second signal to the second device according to the first resource location indication information, the first device may always send the second signal to the second device according to the first resource location indication information, or may perform sending according to a rule, specified by the transmission pattern, for selecting resource locations used for sending the second signal for two consecutive times.

The process of sending according to a rule, specified by the transmission pattern, for selecting resource locations used for sending the second signal for two consecutive times includes the following two cases.

In a first case, when the first resource location indicated by the first resource location indication information corresponds to one pair of coordinates in the transmission pattern, step S402 includes the following steps.

Step S4021: The first device determines a fourth resource location and a fifth resource location according to the transmission pattern, where the fourth resource location is the first resource location indicated by the first resource location indication information.

The fourth resource location is the first resource location indicated by the first resource location indication information. If corresponding coordinates in the transmission pattern are (Tᵢ, fⱼ), the fifth resource location is coordinates (T_{(i+m)modN}, fⱼ) or (T_{(i+p)modN}, f_{(i+q)modN}) in the transmission pattern according to the transmission pattern. The fourth resource location and the fifth resource location are different in a time domain and the same in a frequency domain, or are different in both a time domain and a frequency domain.

Step S4022: The first device sends the second signal to the second device at the fourth resource location, and sends the second signal to the second device at the fifth resource location.

In a second case, when the first resource location indicated by the first resource location indication information corresponds to a plurality of coordinates in the transmission pattern, step S402 further includes the following steps.

Step S4021′: The first device determines a fourth resource location and a fifth resource location according to the transmission pattern, where the fourth resource location is the first resource location indicated by the first resource location indication information.

The fourth resource location is the first resource location indicated by the first resource location indication information. If a plurality of corresponding coordinates in the transmission pattern are three pairs of coordinates, (Tᵢ, f₁), (Tᵢ, f₂), and (Tᵢ, f₃), the fifth resource location needs to change according to the transmission pattern. After the three pairs of coordinates (Tᵢ, f₁), (Tᵢ, f₂), and (Tᵢ, f₃) change according to the transmission pattern, time points Tᵢ are different, and frequency points are also different. Therefore, if the second signal is sent at the fifth resource location, the second signal is dispersed into three resource locations. Consequently decoding the second signal becomes more complex after a device that receives the second signal receives the second signal. The following two sending manners may be selected in this embodiment of the present disclosure.

Step S4022′: The first device sends the second signal to the second device at the fourth resource location, and sends the second signal to the second device at the fifth resource location.

When this manner is used, a relatively high requirement is imposed on decoding performed by a receiving device.

Alternatively, the first device sends the second signal to the second device at the fourth resource location, and the first device does not send the second signal at the fifth resource location.

Further, when the first device does not send the second signal at the fifth resource location, the fifth resource location may be idle, or another device may be instructed to occupy the fifth resource location to send a first signal of the other device. In this case, a sending period in which the first device sends the second signal is twice a sending period of the first signal of the other device.

After sending the second signal to the second device at the first resource location for a first time, the first device periodically sends the second signal at the first resource location according to a preset period. When the first device sends the second signal, the first signal of the first device may be sent at a resource location different from the resource location used for sending the second signal, or may not be sent.

In a possible implementation, when the first signal (which is a new first signal) of the first device is sent at the resource location different from the resource location used for sending the second signal, the first device further sends, to the second device at the resource location different from the resource location used for sending the second signal, a first signal that carries second resource location indication information. The second resource location indication information is used to notify the second device of a sixth resource location at which the first device sends the second signal or the control signal of the second signal. One purpose of this operation is to avoid a problem that some device is always at a location in a dead zone of the resource location at which the first device sends the second signal and can never receive the second signal sent by the first device at the resource location. Another purpose includes if a new device is added to an area in which the first device is located, the new device may receive the first signal of the first device, and learn the resource location at which the first device sends the second signal such that when selecting a resource location used for sending a first signal of the new device, the new device avoids the resource location at which the first device sends the second signal, and can quickly and successfully receive the second signal sent by the first device.

Further, in another possible implementation, because both the first signal and the second signal are limited by half-duplex, when sending a first signal, a device (referred to as a device for which an occupied resource location and the resource location occupied by the first device are dead zones for each other) that occupies a resource location that is the same, in the time domain, as the resource location occupied by the first device can never receive the first signal sent by the first device. In this case, after the sending, by the first device, the second signal to the second device at the first resource location, the method further includes receiving, by the first device, a first signal that carries the first resource location indication information and that is sent by a device belonging to a same area as the first device, where the device belonging to the same area as the first device includes a device whose physical location belongs to a same area as the first device or a device whose discovery signal occupies a resource in a same area as the first device. That is, after receiving the first signal that carries the first resource location indication information and that is sent by the first device, the device belonging to the same area as the first device broadcasts, to another device, the resource location at which the first device sends the second signal, and adds, to a first signal to be sent by the device belonging to the same area as the first device, the resource location indication information that indicates the first resource location. In this way, the device for which the occupied resource location and the resource location occupied by the first device are dead zones for each other may determine, according to the first signal of the device belonging to the same area as the first device, the resource location at which the first device sends the second signal. It should be noted that there may be one device that belongs to a same area as the first device and that sends, to the other device, the first signal carrying the first resource location indication information in order to further save resources.

In this embodiment, the first device sends the first signal at the two resource locations determined according to the transmission pattern, and the two resource locations are different at least in a time domain. To some extent, a conflict that a plurality of devices simultaneously select a same time-frequency resource because the device randomly uses a time-frequency resource in a resource pool to send the first signal can be effectively avoided such that devices quickly receive first signals from each other, and a second signal sent by a device or second signals sent by a plurality of devices can be more quickly and accurately received.

For a specific instance, refer to FIG. 6. FIG. 6 is a schematic diagram of locations in a transmission pattern corresponding to resource locations used by different devices according to an embodiment of the present disclosure. Numbers in FIG. 6 represent the locations in the transmission pattern corresponding to the resource locations used by the different devices. For example, when sending first signals once, devices 1, 4, and 7 occupy a same subframe, and only occupied frequencies are different. In this case, the devices 1, 4, and 7 cannot receive the first signals that are broadcast by each other. In a next time of sending the first signals, the devices 1, 4, and 7 select different subframes according to a rule specified by the transmission pattern such that the devices 1, 4, and 7 can receive the first signals that are broadcast by each other.

Devices that are in a same subframe in one time of sending may select, in a next time of sending, resource locations corresponding to different locations in the transmission pattern in a time domain. As shown in FIG. 6, devices 2, 5, and 8 occupy a same subframe in one time of sending, and devices 3, 6, and 9 occupy a same subframe in one time of sending. The devices 2, 5, and 8 or the devices 3, 6, and 9 may select, in a next time of sending, corresponding different locations in the transmission pattern in the time domain according to the rule specified by the transmission pattern such that the devices 2, 5, and 8 or the devices 3, 6, and 9 can receive, after two times of sending, first signals that are broadcast by each other, and a quantity of times of sending the first signals is effectively reduced. In this way, the devices quickly receive the first signals from each other.

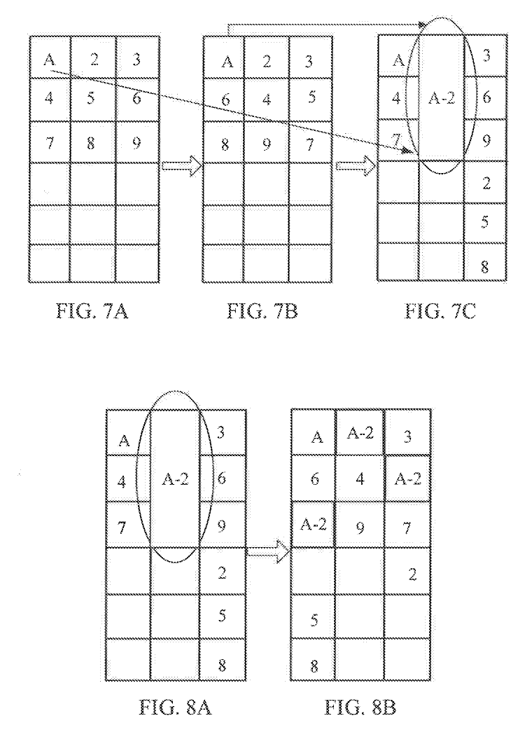

For example, a first signal is a discovery signal and a second signal is a CAM signal. The CAM signal is sent using a D2D discovery channel. For a specific instance, refer to FIG. 7A to FIG. 9C. With reference to FIG. 7A to FIG. 9C, first devices shown in the FIGS. are A. A specific procedure is as follows.

Step S501: A device A sends a discovery signal to a second device, where the discovery signal is sent twice in one period.

There is a plurality of second devices, and a sending manner is broadcasting. FIG. 7A to FIG. 7B are a schematic diagram of transmission patterns in which a device A and other devices 2 to 9 adjacent to the device A send a discovery signal twice in one period. FIG. 7A and FIG. 7B are transmission patterns in which the device A and other devices 2 to 9 adjacent to the device A send a discovery signal twice in one period. Resource location indication information is carried in both times of sending the discovery signal by the device A. A resource location that is used by a first device to send a second signal and that is indicated by the resource location indication information is an A-2 location shown in FIG. 7C, and A-2 occupies three subframe locations.

For example, in one time of sending discovery signals, devices A, 4, and 7 occupy a same subframe, and only occupied frequencies are different. In this case, the devices A, 4, and 7 cannot receive the first signals that are broadcast by each other. In a next time of sending discovery signals, the devices A, 4, and 7 select different subframes according to a rule specified by the transmission pattern such that the devices A, 4, and 7 can receive the discovery signals that are broadcast by each other.

Step S502: The device A sends a CAM signal to the second device according to a resource location A-2 indicated by resource location indication information.

Further, the device A determines a first resource location and a second resource location according to the transmission pattern. FIGS. 8A and 8B are a schematic diagram of the first resource location and the second resource location that are determined by the device A according to the transmission pattern. As shown in FIG. 8A, the first resource location is the resource location A-2 indicated by the resource location indication information, and the second resource location changes according to the rule of the transmission pattern, for example, three subframe locations A-2 shown in FIG. 8B. Then, in one time of sending the CAM signal, the device A occupies A-2 shown in FIG. 8A, and in a next time of sending the CAM signal, the device A occupies A-2 shown in FIG. 8B, or in a next time of sending the CAM signal, the device A still occupies A-2 shown in FIG. 8A. After receiving the discovery signal sent by the first device, the second device learns, using the resource indication information, that a resource location to be occupied by the device A to send the CAM signal is A-2 (subframes used by the original devices 2, 5, and 8) shown in FIG. 8A, avoids the location, and selects another subframe (as shown in FIG. 8A). Therefore, the second device can more quickly and accurately receive the CAM signal sent by the first device.

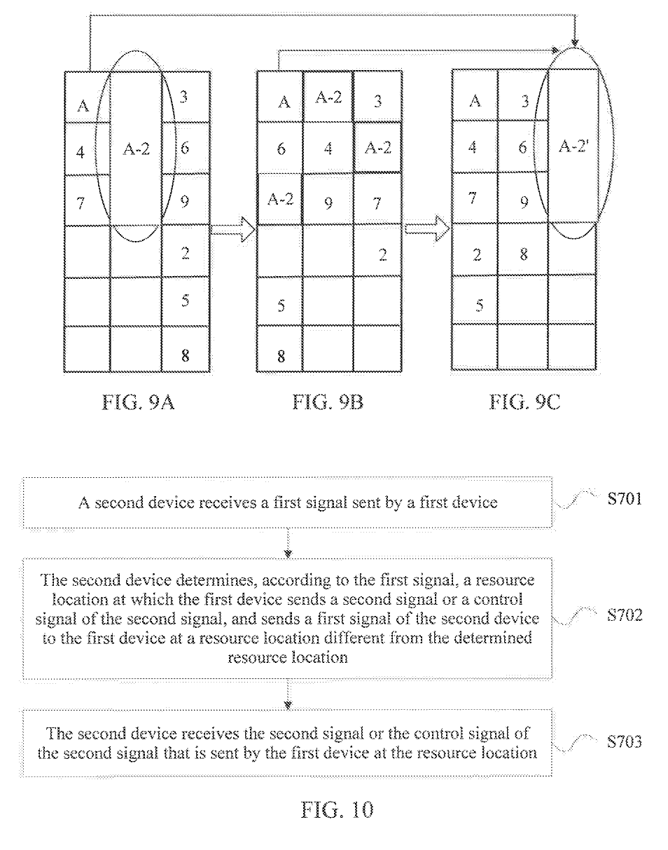

Further, each time the device A sends the CAM signal, the discovery signal of the device A is still sent, and is sent at a resource location different from the resource location used for sending the CAM signal. A sent new discovery signal carries new resource location indication information. FIGS. 9A, 9B and 9C are a schematic diagram of resource locations indicated by resource location indication information carried in two times of sending the new discovery signal by the device A. As shown in FIG. 9C, new resource location indication information is carried in both times of sending the new discovery signal by the device A. A resource location indicated by the new resource location indication information is A-2′, and is used by the device A to send the CAM signal again.

For example, a first signal is a discovery signal and a second signal is a CAM signal. The CAM signal is sent using a D2D communication channel. A specific procedure is as follows.

Step S601: A first device sends a discovery signal to a second device, where the discovery signal is sent twice in one period.

The discovery signal may be sent in any manner in the foregoing embodiments. Resource location indication information is carried in both times of sending the discovery signal by the first device. The resource location indication information is used to indicate a resource location at which the first device sends a control signal of a second CAM signal. For example, the control signal is a scheduling assignment (SA) signal. The resource location indication information is used to indicate a resource location at which the first device sends an SA signal of the CAM signal. The SA signal is sent twice in a resource pool of control signals of communication signals, and the SA signal is used to indicate a resource location, a modulation and coding scheme, and the like that are used for sending the CAM signal, and is used by the second device to receive, demodulate, and decode the CAM signal.

Step S602: The first device sends an SA signal of a CAM signal to the second device at a resource location indicated by resource location indication information.

Step S603: The first device indicates, using the SA signal, control information such as a resource location and a modulation and coding scheme that are used for sending the CAM signal, and sends the CAM signal to the second device at the resource location indicated by the SA signal.

There are two manners herein in which the first device indicates, using the resource location indication information, the resource location at which the first device sends the control signal of the CAM signal. In a first manner, the first device indicates, using the resource location indication information, a specific PRB location or a resource bitmap used by the first device to send the control signal of the CAM signal. In a second manner, the first device indicates, using the resource location indication information, an index (Index) used by the first device to send the control signal of the second signal.

FIG. 10 is a schematic flowchart of Embodiment 5 of an information transmission method according to the present disclosure. As shown in FIG. 10, the method in this embodiment may include the following steps.

Step S701: A second device receives a first signal sent by a first device.

Step S702: The second device determines, according to the first signal, a resource location at which the first device sends a second signal or a control signal of the second signal, and sends a first signal of the second device to the first device at a resource location different from the determined resource location.

Further, there are two possible implementations for step S702 in which the second device determines, according to the first signal, the resource location at which the first device sends the second signal or the control signal of the second signal. In one possible implementation, the first signal carries first resource location indication information, and the first resource location indication information is used to indicate a first resource location at which the first device sends the second signal or the control signal of the second signal. If the first resource location indication information is used to indicate the first resource location at which the first device sends the second signal, after receiving the first signal, when sending the first signal of the second device, the second device does not use a resource location that is the same as the first resource location, but selects another available resource location. A resource location that is different in a time domain or both a time domain and a frequency domain may be selected. Therefore, a conflict between the first signal sent by the second device and the second signal sent by the first device can be avoided such that the second device can quickly and accurately receive the second signal sent by the first device. If the first resource location indication information is used to indicate the first resource location at which the first device sends the control signal of the second signal, after receiving the first signal, the second device does not use the first resource location to send the first signal of the second device, but selects another available resource location. Therefore, a conflict between the first signal sent by the second device and the second signal sent by the first device can be avoided such that the second device can quickly and accurately receive the second signal sent by the first device.

The first resource location indication information may include at least one bit, used to indicate whether to send the second signal in a next period of a current period. For example, “1” represents yes, and “0” represents no. The first signal may include a resource bitmap, a control signal index, or at least two of a PRB start location, a PRB end location, or a PRB quantity, used to indicate the resource location used for sending the second signal or the control signal of the second signal.

In the other possible implementation, the second device determines, according to a preset relationship and a resource location used for sending the first signal, the resource location at which the first device sends the second signal or the control signal of the second signal. The preset relationship is a relationship between the resource location used for sending the first signal and the resource location used for sending the second signal or the control signal of the second signal, and the preset relationship is pre-stored on the first device and the second device.

Further, the preset relationship may be a calculation formula. The preset relationship may be configured by a third-party device (such as a base station or a control node) for the first device and the second device, or the preset relationship may be generated by the first device, the first device generates the preset relationship and then sends the relationship to the second device, and the preset relationship may be sent together with the first signal or may be sent before or after the first signal. It should be noted that regardless of whether the preset relationship is configured by the third-party device or generated by the first device, the preset relationship takes effect after the second signal is triggered. For example, whether the second signal is sent may be indicated in the first signal (for example, indicated by the at least one bit in Embodiment 2), and if the second signal is sent, the second signal is triggered. Such triggering may be independent of the first signal, and the second device is notified on another channel that the second signal is triggered.

Step S703: The second device receives the second signal or the control signal of the second signal that is sent by the first device at the resource location.

According to the information transmission method provided in this embodiment, after receiving the first signal sent by the first device, the second device determines, according to the first resource location indication information carried in the first signal, the resource location at which the first device sends the second signal or the control signal of the second signal, or determines, according to the preset relationship and the resource location used for sending the first signal, the resource location at which the first device sends the second signal or the control signal of the second signal, and when sending the first signal of the second device, the second device does not use a resource location that is the same as the resource location at which the first device sends the second signal, but selects another available resource location. Therefore, a conflict between the first signal sent by the second device and the second signal sent by the first device can be avoided such that the second device can quickly and accurately receive the second signal sent by the first device.

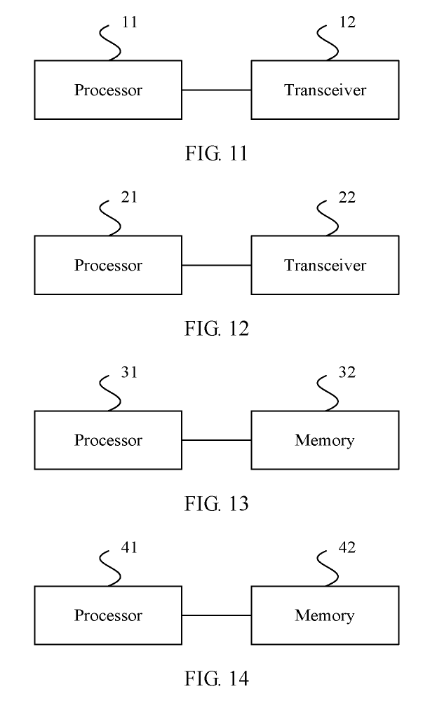

FIG. 11 is a schematic structural diagram of Embodiment 1 of a communications device according to the present disclosure. As shown in FIG. 11, the communications device used as a first device in this embodiment may include a processor 11 and a transceiver 12. The processor 11 is configured to send a first signal to a second device using the transceiver 12, where the first signal is used to enable the second device to determine, according to the first signal, a resource location at which the first device sends a second signal or a control signal of the second signal, and send a first signal of the second device at a resource location different from the determined resource location, and send the second signal or the control signal of the second signal to the second device at the resource location using the transceiver 12.

Optionally, the first signal carries first resource location indication information, and the first resource location indication information is used to indicate a first resource location at which the first device sends the second signal or the control signal of the second signal.

Optionally, the first resource location indication information includes at least one bit, used to indicate whether to send the second signal in a next period of a current period, and a resource bitmap, a control signal index, or at least two of a PRB start location, a PRB end location, or a PRB quantity, used to indicate the resource location used for sending the second signal or the control signal of the second signal.

Optionally, when sending the first signal to the second device using the transceiver 12, the processor 11 is further configured to determine a second resource location and a third resource location according to a transmission pattern, send the first signal to the second device at the second resource location, and send the first signal to the second device at the third resource location.

The transmission pattern includes a time axis and a frequency axis, the time axis includes N time points (T₁, T₂, . . . , and T_{N}), the frequency axis includes N frequency points (f₁, f₂, . . . , and f_{N}), and each pair of coordinates (Tₓ, f_{y}) in the transmission pattern corresponds to a resource location, the second resource location corresponds to first coordinates (Tᵢ, fⱼ) in the transmission pattern, and the third resource location corresponds to second coordinates (T_{(i+m)modN}, fⱼ) or (T_{(i+p)modN}, f_{(i+q)modN}) in the transmission pattern, where N, i, j, x, and y are positive integers, none of i, j, x, and y are greater than N, i+m≤N, and m, p, and q are 0 or positive integers.

Optionally, when sending the second signal to the second device at the resource location using the transceiver 12, the processor 11 is further configured to determine a fourth resource location and a fifth resource location according to the transmission pattern, where the fourth resource location is the first resource location indicated by the first resource location indication information, and send the second signal to the second device at the fourth resource location using the transceiver 12, and send the second signal to the second device at the fifth resource location using the transceiver 12, or send the second signal to the second device at the fourth resource location using the transceiver 12, and skip sending the second signal at the fifth resource location.

Optionally, after sending the second signal to the second device at the resource location using the transceiver 12, the processor 11 is further configured to send, to the second device using the transceiver 12 and a resource location different from the resource location used for sending the second signal, a first signal that carries second resource location indication information, where the second resource location indication information is used to notify the second device of a sixth resource location at which the first device sends the second signal or the control signal of the second signal.

Optionally, after sending the second signal to the second device at the resource location using the transceiver 12, the processor 11 is further configured to receive, using the transceiver 12, a first signal that carries the first resource location indication information and that is sent by a device belonging to a same area as the first device, where the device belonging to the same area as the first device includes a device whose physical location belongs to a same area as the first device or a device whose first signal occupies a resource location in a same area as the first device.

Optionally, after sending the first signal to the second device using the transceiver 12, the processor 11 is further configured to determine, according to a preset relationship and a resource location used for sending the first signal, the resource location at which the first device sends the second signal or the control signal of the second signal, where the preset relationship is a relationship between the resource location used for sending the first signal and the resource location used for sending the second signal or the control signal of the second signal, and the preset relationship is pre-stored on the first device and the second device.

Optionally, when sending the first signal to the second device using the transceiver 12, the processor 11 is further configured to determine a second resource location and a third resource location according to a transmission pattern, send the first signal to the second device at the second resource location using the transceiver 12, and send the first signal to the second device at the third resource location.

The transmission pattern includes a time axis and a frequency axis, the time axis includes N time points (T₁, T₂, . . . , and T_{N}), the frequency axis includes N frequency points (f₁, f₂, . . . , and f_{N}), and each pair of coordinates (Tₓ, f_{y}) in the transmission pattern corresponds to a resource location, the second resource location corresponds to first coordinates (Tᵢ, fⱼ) in the transmission pattern, and the third resource location corresponds to second coordinates (T_{(i+m)modN}, fⱼ) or (T_{(i+p)modN}, f_{(i+q)modN}) in the transmission pattern, where N, i, j, x, and y are positive integers, none of i, j, x, and y are greater than N, i+m≤N, and m, p, and q are 0 or positive integers.

Optionally, when sending the second signal to the second device at the resource location using the transceiver 12, the processor 11 is further configured to determine a fourth resource location and a fifth resource location according to the transmission pattern, where the fourth resource location is the resource location, send the second signal to the second device at the fourth resource location using the transceiver 12, and send the second signal to the second device at the fifth resource location using the transceiver 12, or send the second signal to the second device at the fourth resource location using the transceiver 12, and skip sending the second signal at the fifth resource location.

The communications device in this embodiment may be configured to execute the technical solution executed by the first device in each method embodiment of the present disclosure. An implementation principle and a technical effect of the communications device are similar to those of the first device, and details are not described herein again.

FIG. 12 is a schematic structural diagram of Embodiment 2 of a communications device according to the present disclosure. As shown in FIG. 12, the communications device used as a second device in this embodiment may include a processor 21 and a transceiver 22.

The processor 21 is configured to receive, using the transceiver 22, a first signal sent by a first device, determine, according to the first signal, a resource location at which the first device sends a second signal or a control signal of the second signal, and send a first signal of the communications device to the first device at a resource location different from the determined resource location, and receive, using the transceiver 22, the second signal or the control signal of the second signal that is sent by the first device at the resource location.

Optionally, the first signal carries first resource location indication information, and the first resource location indication information is used to indicate a first resource location at which the first device sends the second signal or the control signal of the second signal.

Optionally, the first resource location indication information includes at least one bit, used to indicate whether to send the second signal in a next period of a current period, and a resource bitmap, a control signal index, or at least two of a PRB start location, a PRB end location, or a PRB quantity, used to indicate the resource location used for sending the second signal or the control signal of the second signal.

Optionally, when determining, according to the first signal, the resource location at which the first device sends the second signal or the control signal of the second signal, the processor 21 is further configured to determine, according to a preset relationship and a resource location used for sending the first signal, the resource location at which the first device sends the second signal or the control signal of the second signal, where the preset relationship is a relationship between the resource location used for sending the first signal and the resource location used for sending the second signal or the control signal of the second signal, and the preset relationship is pre-stored on the first device and the second device.

The communications device in this embodiment may be configured to execute the technical solution executed by the second device in each method embodiment of the present disclosure. An implementation principle and a technical effect of the communications device are similar to those of the second device, and details are not described herein again.

FIG. 13 is a schematic structural diagram of Embodiment 3 of a communications device according to the present disclosure. As shown in FIG. 13, the communications device used as a first device in this embodiment may include a processor 31 and a memory 32. The memory 32 stores an execution instruction. When the communications device in this embodiment runs, the processor 31 communicates with the memory 32. The processor 31 invokes the execution instruction in the memory 32 to execute the solution executed by the first device in each method embodiment of the present disclosure. An implementation principle and a technical effect of the communications device are similar to those of the first device, and details are not described herein again.

FIG. 14 is a schematic structural diagram of Embodiment 4 of a communications device according to the present disclosure. As shown in FIG. 14, the communications device used as a second device in this embodiment may include a processor 41 and a memory 42. The memory 42 stores an execution instruction. When the communications device in this embodiment runs, the processor 41 communicates with the memory 42. The processor 41 invokes the execution instruction in the memory 42 to execute the solution executed by the second device in each method embodiment of the present disclosure. An implementation principle and a technical effect of the communications device are similar to those of the second device, and details are not described herein again.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes any medium that can store program code, such as a read-only memory (ROM), a random access memory (RAM), a magnetic disk, or an optical disc.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

1.-10. (canceled)

11. An information transmission method, comprising:
receiving, by a second device, a first signal from a first device;
determining, by the second device according to the first signal, a resource location at which the first device sends a second signal or a control signal of the second signal;
sending, by the second device, a first signal of the second device to the first device at a resource location different from the determined resource location; and
receiving, by the second device, the second signal or the control signal of the second signal from the first device at the resource location.

12. The method according to claim 11, wherein the first signal carries first resource location indication information indicating a first resource location at which the first device sends the second signal or the control signal of the second signal.

13. The method according to claim 12, wherein the first resource location indication information comprises:
at least one bit indicating whether to send the second signal in a next period of a current period; and
a resource bitmap, a control signal index, at least two of a physical resource block (PRB) start location, a PRB end location, or a PRB quantity indicating the resource location used for sending the second signal or the control signal of the second signal.

14. The method according to claim 11, wherein determining the resource location at which the first device sends the second signal or the control signal of the second signal comprises determining, by the second device according to a preset relationship and a resource location used for sending the first signal, the resource location at which the first device sends the second signal or the control signal of the second signal wherein the preset relationship is a relationship between the resource location used for sending the first signal and the resource location used for sending the second signal or the control signal of the second signal, and wherein the preset relationship is pre-stored on the first device and the second device.

15. A communications device, used as a first device, comprising:
a transceiver; and
processor coupled to the transceiver and configured to:
send a first signal to a second device using the transceiver; and
send a second signal or a control signal of he second signal to the second device at a resource location using the transceiver.

16. The communications device according to claim 15, wherein the first signal carries first resource location indication information indicating a first resource location at which the first device sends the second signal or the control signal of the second signal.

17. The communications device according to claim 16, wherein the first resource location indication information comprises:
at least one bit indicating whether to send the second signal in a next period of a current period; and
a resource bitmap, a control signal index, at least two of a physical resource block PRB start location, a PRB end location, or a PRB quantity indicating the resource location used for sending the second signal or the control signal of the second signal.

18. The communications device according to claim 16, wherein when sending the first signal to the second device using the transceiver, the processor is further configured to:
determine a second resource location and a third resource location according to a transmission pattern;
send the first signal to the second device at the second resource location; and
send the first signal to the second device at the third resource location,
wherein the transmission pattern comprises a time axis comprising N time points (T₁, T₂, . . . , and T_{N}) and a frequency axis, comprising N frequency points (f₁, f₂, . . . , and f_{N}),
wherein each pair of coordinates (Tₓ, f_{y}) in the transmission pattern corresponds to a resource location,
wherein the second resource location corresponds to first coordinates (Tᵢ, fⱼ) in the transmission pattern,
wherein the third resource location corresponds to second coordinates T_{(i+m)mod N}, fⱼ) or (T_{(i+p)modN}, f_{(i+q)mod N}) in the transmission pattern,
wherein N, i, j, x, and y are positive integers,
wherein none of i, j, x, and y are greater than N,
wherein i+m≤N, and
wherein m, p, and q are 0 or positive integers.

19. The communcations device according to claim 18, wherein when sending the second signal to the second device at the resource location using the transceiver, the processor is further configured to:
determine a fourth resource location and a fifth resource location according to the transmission pattern, wherein the fourth resource location comprises the first resource location from the first resource location indication information;
send the second signal to the second device at the fourth resource location using the transceiver; and
send the second signal to the second device at the fifth resource location using the transceiver.

20. The communications device according to claim 15, wherein the processor is further configured to send, to the second device using the transceiver and a resource location different from the resource location used for sending the second signal, a first signal carrying second resource location indication information after sending the second signal to the second device at the resource location using the transceiver, and wherein the second resource location indication information notifies the second device of a sixth resource location at which the first device sends the second signal or the control signal of the second signal.

21. The communications device according to claim 15, wherein the processor is further configured to receive, using the transceiver, a first signal carrying the first resource location indication information from a device belonging to a same area as the first device after sending the second signal to the second deice at the resource location using the transceiver, and wherein the device belonging to the same area as the first device comprises a device whose physical location belongs to the same area as the first device or a device whose first signal occupies a resource location in the same area as the first device.

22. The communication device according to claim 15, wherein the processor is further configured to determine, according to a preset relationship and a resource location used for sending the first signal, the resource location at which the first device sends the second signal or the control signal of the second signal after sending the first signal to the second device using the transceiver, wherein the preset relationship is a relationship between the resource location used for sending the first signal and the resource location used for sending the second signal or the control signal of the second signal, and wherein the preset relationship is pre-stored on the first device and the second device.

23. The communication device according to claim 22, wherein when sending the first signal to the second device using the transceiver, the processor is further configured to:
determine a second resource location and a third resource location according to a transmission pattern;
send the first signal to the second device at the second resource location using the transceiver; and
send the first signal to the second device at the third resource location using the transceiver,
wherein the transmission pattern composes a time axis comprising N time points (T₁, T₂, . . . , and T_{N}) and a frequency axis comprising N frequency points (f₁, f₂, . . . , and f_{N}),
wherein each pair of coordinates (Tₓ, f_{y}) in the transmission pattern corresponds to a resource location,
wherein the second resource location corresponds to first coordinates (Tᵢ, fⱼ) in the transmission pattern,
wherein the third resource location corresponds to second coordinates (T_{(i+m)modN}, fⱼ) or (T_{(i+p)modN}, f_{(i+q)modN}) in the transmission pattern,
wherein N, i, j, x, and y are positive integers,
wherein none of i, j, x, and y are greater than N,
wherein i+m≤N, and
wherein m, p, and q are 0 or positive integers.

24. The communications device according to claim 23, wherein when sending the second signal to the second device at the resource location using the transceiver, the processor is further configured to:
determine a fourth resource location and a fifth resource location according to the transmission pattern, wherein the fourth resource location comprises the resource location;
send the second signal to the second device at the fourth resource location using the transceiver; and
send the second signal to the second device at the fifth resource location using the transceiver.

25. A communications device, used as a second device, comprising:
a transceiver; and
a processor coupled to the transceiver and configured to:
receive, using the transceiver, a first signal from a first device;
determine, according to the first signal, a resource location at which the first device sends a second signal or a control signal of the second signal;
send, using the transceiver, a first signal of the communications device to the first device at a resource location different from the determined resource location; and
receive, using the transceiver, the second signal or the control signal of the second signal from the first device at the resource location.

26. The communication device according to claim 25, wherein the first signal carries first resource location indication information indicating a first resource location at which the first device sends the second signal or the control signal of the second signal.

27. The communication device according to claim 26, wherein the first resource location indication information comprises:
at least one bit indicating whether to send the second signal in a next period of a current period; and
a resource bitmap, a control signal index, at least two of a physical resource block (PRE) start location, a PRB end location, or a PRB quantity indicating the resource location used for sending the second signal or the control signal of the second signal.

28. The communications device according to claim 25, wherein when determining the resource location at which the first device sending the second signal or the control signal of the second signal, the processor is further configured to determine, according to a preset relationship and a resource location used for sending the first signal, the resource location at which the first device sends the second signal or the control signal of the second signal, wherein the preset relationship is a relationship between the resource location used for sending the first signal and the resource location used for sending the second signal or the control signal of the second signal, and wherein the preset relationship is pre-stored on the first device and the second device.

29. The communications device according to claim 18, wherein when sending the second signal to the second device at the resource location using the transceiver, the processor is further configured to:
determine a fourth resource location and a fifth resource location according to the transmission pattern, wherein the fourth resource location comprises the first resource location from the first resource location indication information;
send the second signal to the second device at the fourth resource location using the transceiver; and
skip sending the second signal at the fifth resource location.

30. The communications device according to claim 23, wherein when sending the second signal to the second device at the resource location using the transceiver, the processor is further configured to:
determine a fourth resource location and a fifth resource location according to the transmission pattern, wherein the fourth resource location comprises the resource location;
send the second signal to the second device at the fourth resource location using the transceiver; and
skip sending the second signal at the fifth resource location.
